(19) United States
(12) Patent Application Publication
(10) Pub. No.: US 2020/0236406 A1
(43) Pub. Date: Jul. 23, 2020

(54) NETWORKING FOR DISTRIBUTED MICROSERVICES COMMUNICATION FOR REAL-TIME MULTI-VIEW COMPUTER VISION STREAMING APPLICATIONS

(71) Applicants: Waldo Bastian, Beaverton, OR (US); Alex Kalnizky, Petah Tikva (IL); Oren Cohen, Tel-Mond (IL); Jay Daka, Zemer (IL); Ben Rotman, Tel-Aviv (IL); Karen Abramyanc, Bat-Yam (IL)

(72) Inventors: Waldo Bastian, Beaverton, OR (US); Alex Kalnizky, Petah Tikva (IL); Oren Cohen, Tel-Mond (IL); Jay Daka, Zemer (IL); Ben Rotman, Tel-Aviv (IL); Karen Abramyanc, Bat-Yam (IL)

(21) Appl. No.: 16/789,875

(22) Filed: Feb. 13, 2020

(51) Int. Cl. H04N 21/218; H04N 21/2187; H04N 19/176; H04N 19/597

(52) U.S. Cl. CPC H04N 21/21805; H04N 19/597; H04N 19/176; H04N 21/2187

(57) ABSTRACT

Methods, apparatus, systems and software for distributed microservices communication for real-time multi-view computer vision streaming applications. In one aspect, a method for producing immersive sports video content is provided. A plurality of video feeds from a plurality of physical cameras (PCams) installed in a stadium or venue are received at a data center, where the PCams have respective viewpoints directed toward at least one of a field or court in the stadium or venue and one or more players participating in a sport being played in the stadium or venue. The plurality of video feeds are processed in parallel at the data center using a plurality of distributed stateful and stateless processing services to generate a three-dimensional point cloud comprising a volumetric model including a plurality of voxels and process the plurality of voxels from each of a plurality of viewpoints associated with respective virtual cameras (VCams) to output video streams in real-time.

### BACKGROUND INFORMATION

Immersive media technologies enable users to view live events as if they were attending the event in person and watch replays from multiple angles and perspectives. Examples of immersive media technology include Intel® True View and Intel® True VR, which are currently being used in sports stadiums in the US and abroad including National Football League (NFL) stadiums and English Premiere League stadiums.

As illustrated in FIG. 1, and array of high-definition 5K cameras are installed in a ring around a stadium or venue 100, capturing the entire field of play. The cameras, referred to a physical cameras or PCams 102 generate massive amounts of volumetric data (voxels), which capture height, width, and depth. The cameras are connected via fiber 104 to a cluster of (e.g., 50) servers 106 at the stadium/venue. The high-performance servers store, synchronize, analyze, and render terabytes of volumetric data that is turned into high-fidelity 3D video content that can be viewed from a wide variety of angles and perspectives.

Among the features provided by this technology is the ability to create volumetric frames that can be viewed using 3D rotation rotated in a manner made famous by the Matrix movie. Currently, such volumetric frames take about 30 seconds to be produced with the on-premise servers.

When transitioning from a single frame to real-time (e.g., 30 or 60 2frames per second) volumetric video, the amount of computing power needs to be multiplied by 900 or 1800. In view of recent developments in cloud infrastructure, a cloud compute solution can theoretically handle such task, but currently there is no solution present that can handle the requirements of real-time, high computation, high-bandwidth, and low latency processing that will be stable enough for a production level application.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating an overview of a current implementation of Intel® True View and Intel® True VR under which video streams output from a plurality of physical cameras (PCams) located in a stadium or venue are processed using servers at the stadium or venue;

FIG. 2 is a diagram of an end-to-end processing pipeline for multi-view volumetric video processing, according to one embodiment;

FIG. 3 is a diagram illustrating further processing components for implementing the end-to-end processing pipeline of FIG. 2, according to one embodiment;

FIGS. 4a, 4b, and 4c are schematic diagrams illustrating selective portions of a distributed architecture in which aspects of the embodiments disclosed herein may be implemented, wherein FIG. 4a illustrates a plurality of decoder instances, Flink instances, MV instances, DXT instances and stream aggregator instances, FIG. 4b further illustrates a plurality of media processing services and CVT instances, and FIG. 4c further illustrates a plurality of localisation instances, segmentation instances, reconstruction instances, camera engine instances and render instances;

FIG. 5 is a schematic diagram of a process flow and communication architecture illustrating selected service flow control components, services, and communication paths, according to one embodiment;

FIG. 6 is a diagram illustrating a sample computer vision execution flow used in a multi-view application for volumetric reconstruction, according to one embodiment;

FIG. 7 a schematic diagram illustrating a process pipeline for a service worker, according to one embodiment;

FIG. 8 is a diagram illustrating a round robin routing policy, according to one embodiment;

FIG. 9 is a schematic diagram of a processing sub-system that uses stateless workers within stateful clusters and includes components and messaging for preserving temporal state and coordination process flows to effect synchronized configuration updates, according to one embodiment; and

FIG. 10 is a diagram of a caching and synchronization policy decision tree, according to one embodiment

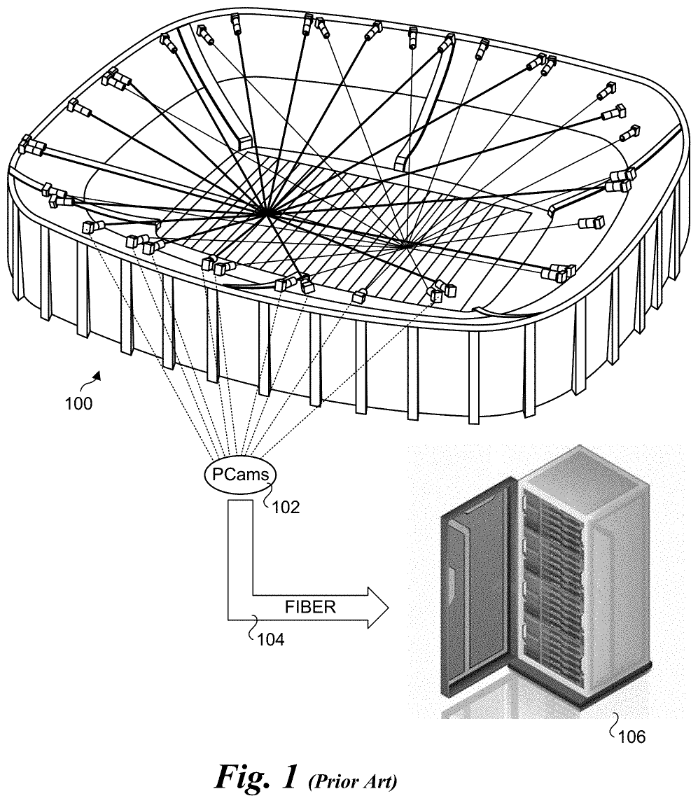

### DETAILED DESCRIPTION

Embodiments of methods, apparatus, systems and software for distributed microservices communication for real-time multi-view computer vision streaming applications are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

In accordance with aspects of the embodiments disclosed herein, novel implementations of microservices to support real-time high-performance video systems are provided. The implementations combine server mesh approach, controlled invocation and dynamic routing in order to maximize efficiency. This provides a novel solution through the combination of microservices architecture with time-bounded execution networking that enables real-time, low-latency, high performance and high throughput applications such as multi-view volumetric video processing.

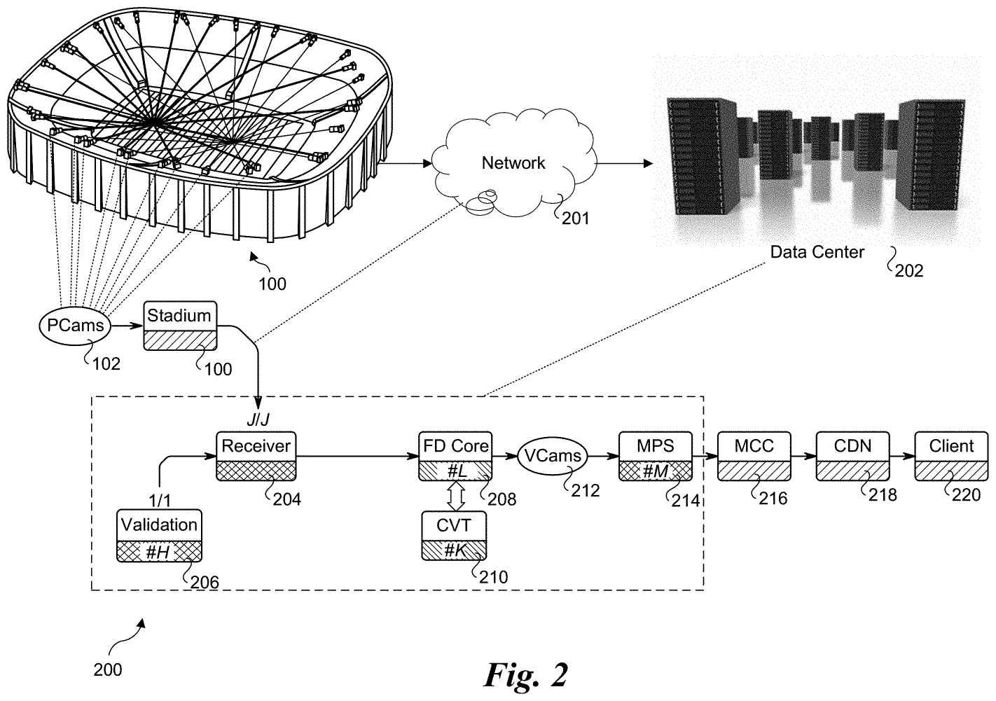

FIG. 2 shows an end-to-end processing pipeline 200 for multi-view volumetric video processing, according to one embodiment. 2D digital video feeds output by J physical cameras (PCams) 102 installed in a stadium 100 are delivered from a stadium feed over network infrastructure 201 to a video receiver block 204 located at a data center 202 that is remote from stadium 100. In one embodiment there are 38 (J) PCams; however, this is merely exemplary, as a greater or a smaller number of PCams may be used. The output from receiver block 204 is fed in to L instances of “Free-Dimensional” (FD) Core block 208. FD Core block 208 receives (from receiver 204) 2D video output by PCams 202 and reconstructs a 3D point cloud of voxels. The 3D point cloud voxels are used to render a plurality of video scenes that represent viewpoints from multiple virtual cameras (VCams) 212, where the video scenes associated with each VCam 212 are from unique angles and/or perspective relative to the other VCams. FD Core block 208 also interacts with K instances of Computer Vision Team (CVT) block 210, which perform computer vision algorithms such as ball detection and player detection.

A validation block 206 is used to generate video signals representative of video feeds from one or more of PCams 102 that are used to validate performance of the system. This enables components in the processing pipeline to be tested and performance evaluated when live video feeds are not available, as well as for other purposes.

The rendered video scenes for a given VCam 212 comprise 2D streaming video content that is send to the Media Processing Services (MPS) block 214, which forwards the streams into a Media Control Center 216, where various operators select feeds from M different VCams 212 to output to a Content Delivery Network 218 that is used to delivery streaming video content to a client 220.

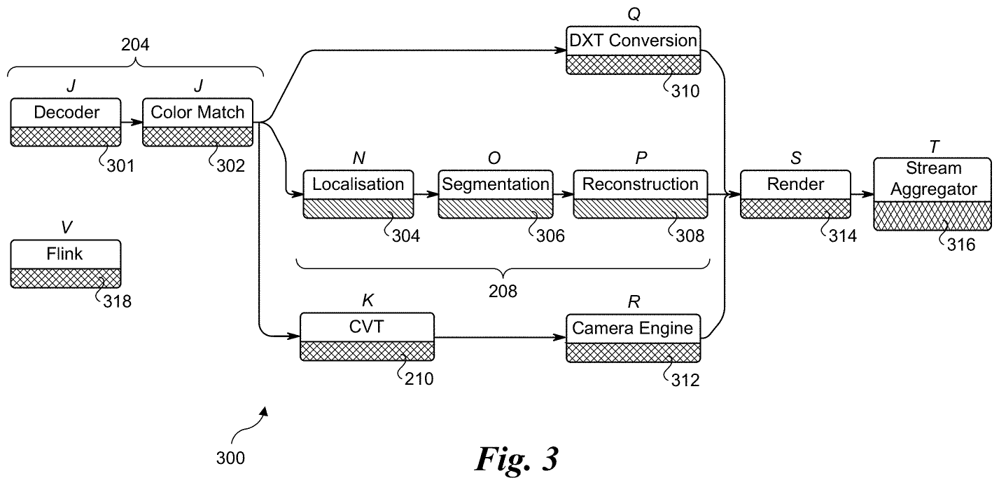

FIG. 3 shows a processing flow diagram 300 including processes associated with receiver 204, FD Core block 208, and CVT block 210, according to one embodiment. The 2D video feeds received from PCams 202 (via video receiver block 204) comprise encoded video streams that are decoded using a decoder 301, which outputs decoded 2D frames of video content comprising an 2D (XY) array of pixels. The pixels in the 2D frames are then processed by a color match block 302, which is configured to provide consistent color encoding across the decoded video streams. In one embodiment, there is a respective instance of decoder 300 and color match block 302 for each of the J PCams 102. Alternatively, the number of instances of decoder 300 and color match block 302 may differ.

The 2D pixel data output from color match block 302 is fed through an image processing pipeline including a localization block 304, a segmentation block 306, and a reconstruction block 308. Localization block 304 uses image processing to identify the approximate location of players within the field of view of the given 2D video frames. For example, the output of localization block 304 is a video frame with boxes indicating the location of content of interest in the frame (e.g., generates rectangular boxes outlining the location of individual players, group of players, the ball, etc.). Segmentation block 306 is used to further processes the content within the localized boxes to separate the players, ball, etc., from the background (e.g., football field, soccer pitch, basketball court, etc.)

Reconstruction block 308 is used to reconstruct the 2D pixels into 3D voxels. For example, consider generation of the voxels for an individual player. The output from segmentation block 306 may include 2D pixel data from up to J viewpoints, where J represents the number of PCams (e.g., 38 in the present example). The 2D pixel data is processed by reconstruction block 308 to generate the voxels from the 2D pixel data using mathematical algorithms. The voxels generated by reconstruction block 308 comprise a 3D point cloud that can be viewed from any angle.

In parallel to the foregoing pipeline operations, the 2D video frame output from color match block 302 is converted into a DXT format by DXT conversion block 310. DXT, also known as S3CT (S3 Compressed Texture) and BC (Block Compression), is a group of related lossy texture compression algorithms originally developed by the S3 Graphics Corporation and is supported by various standardized graphics libraries, such as OpenGL. The formats include DXT1, DXT2, DXT3, DXT4, and DXT5. The DXT convertor converts the 2D frame data into compressed bitmap textures having one or more of these formats. In one embodiment, the format is DXT1.

A render block 314 receives the outputs of DXT conversion block 310 and reconstruction block 308 and renders VCam views (in the form of video frames) based on control input from a camera engine 312. For instance, control input from camera engine 312 is used to select the VCam viewpoint, which may be static or dynamic. The VCam video frames output from render block 314 are then aggregated by a stream aggregator 316.

In parallel to the foregoing pipeline operations, the 2D video frame output from color match block 302 is send to the CVT block 210 which performs computer vision algorithms such as ball detection and player detection. The information deduced this way is sent by the CVT block 210 to the Camera Engine block 312. The Camera Engine block 312 in turn uses this information to create dynamic VCam viewpoints.

The italicized letters above the various block and components in FIG. 2 represent a corresponding number of instances of that block or component. For example, in the illustrated embodiment there are N=250 instances of localization block 304, O=200 instances of segmentation block 206, P=50 instances of reconstruction block 308, Q=150 instances of DXT conversion block 312, S=20 instances of render block 314 and T=10 instances of stream aggregator 316. Thus, the process involves coordination of processing tasks being performed on a large number of servers, observing that the foregoing values for N, O, P, Q, S, and T are exemplary and non-limiting. The coordination is managed, in part, by a flow controller 318, also referred to as an orchestrator. In one embodiment, flow controller 318 is implemented as an application on top of the Apache Flink framework. Apache Flink is an open-source stream-processing framework and distributed processing engine for stateful computations over unbounded and bounded data streams developed by the Apache Software Foundation. In one embodiment there are V=9 Flink instances. In one embodiment, each instance of decoder 300, color match block 302, localization block 304, segmentation block 306, reconstruction block 308, DXT conversion block 310, render block 314 and stream aggregator 316 is implemented as a microservice. For convenience, the microservices may also be referred to simply as services herein in both the text and drawings.

In general, the processes implemented by decoder block 300, color match block 302, localisation block 304, segmentation block 306, reconstruction block 308, DXT conversion block 310, render block 314 and stream aggregator block 316 may be implemented using techniques and/or algorithms that are known in the video processing arts. In one embodiment, one or more of these processes may be implemented using techniques disclosed in US Patent Application Publication No. 20150317822A1 (Oren Haimovitch-Yogev et al.).

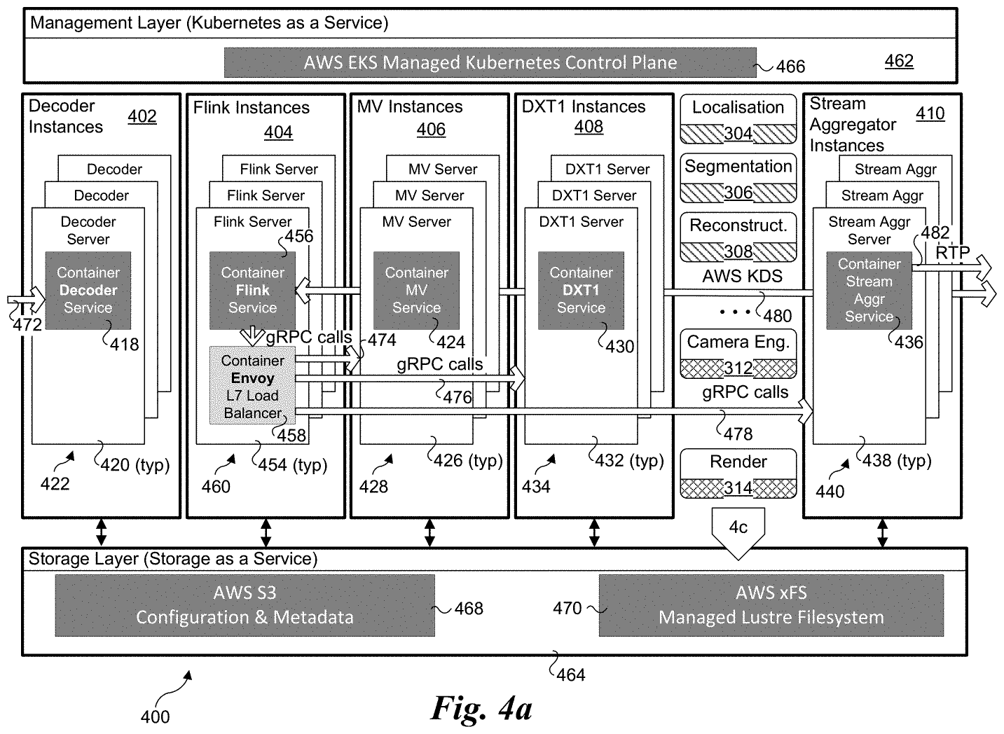

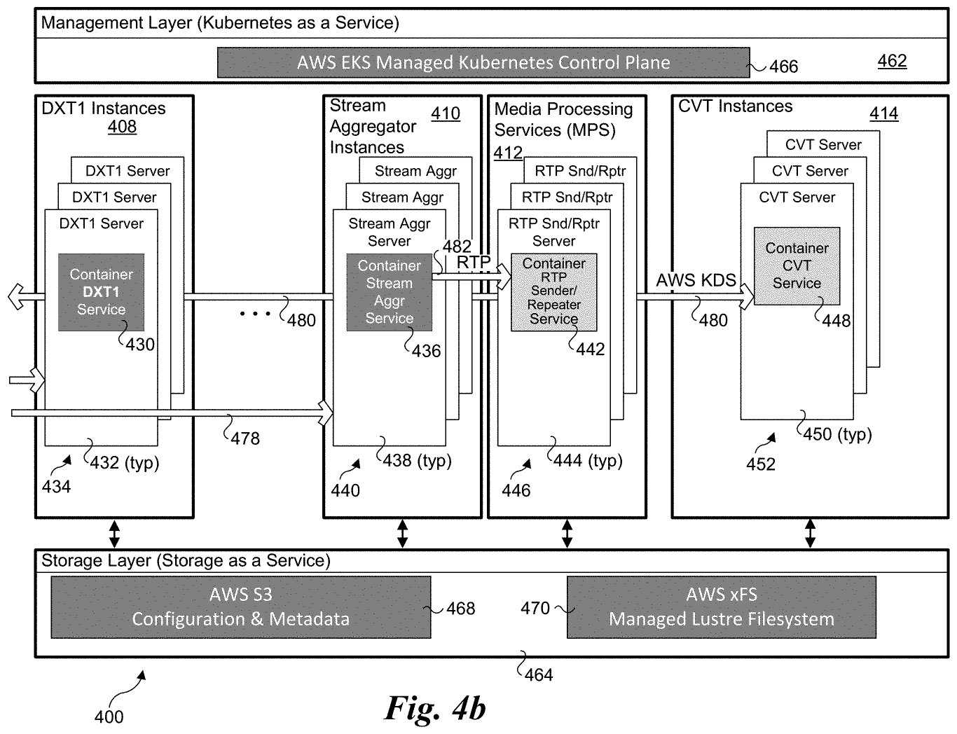

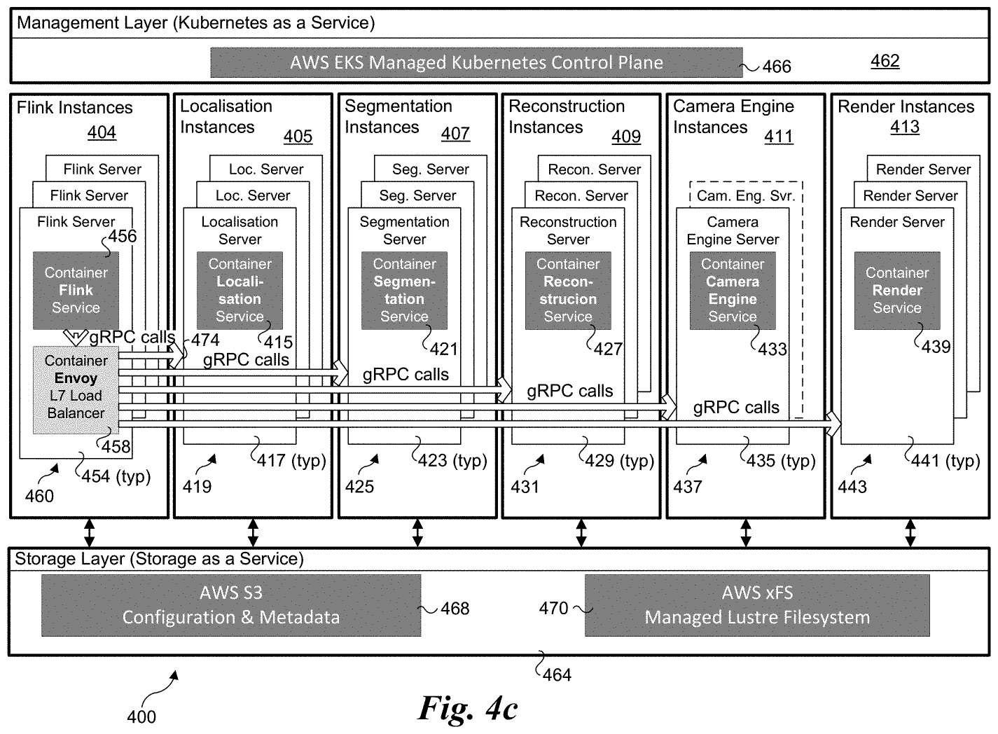

FIG. 4a shows a cloud-hosted distributed architecture 400, with further details shown in FIGS. 4b and 4c. In the illustrated embodiment, at a top level various microservice instances are logically grouped by instance type and computational domain, as depicted by decoder instances 402, Flink instances 404, multi-view (MV) 406, DXT1 instances 408, stream aggregator instances 410, media processing services 412 and CVT instances 414. Each set of service instances in a given computational domain are run on a cluster of servers implemented for that computational domain. Under distributed architecture 400, each service instance comprises an application that is run in a respective container. In turn in one embodiment each container is hosted on a respective server, with the set of servers for a given computational domain comprising a cluster.

Accordingly, as shown in FIG. 4a, decoder instances 402 includes a set of decoder service instances 418 run in respective containers hosted on servers 420 that collectively comprise a decoder service cluster 422. Similarly, MV instances 406 includes a set of MV service instances 424 run in respective containers hosted on servers 426 that collectively comprise an MV service cluster 428; DXT1 instances 408 includes a set of DXT1 service instances 430 run in respective containers hosted on servers 432 that collectively comprise a DXT1 service cluster 434; and stream aggregator instances 410 includes a set of stream aggregator service instances 436 run in respective containers hosted in servers 438 that collectively comprise a stream aggregator service cluster 440. As further shown in FIG. 4b, MPS instances 412 includes a set of RTP sender/repeater service instances 442 run in respective containers hosted on RTP sender/repeater servers 444 that collectively comprise an MPS cluster 446, and CVT instances 414 includes a set of CVT service instances 448 run in respective containers hosted on CVT servers 450 that collectively comprise a CVT service cluster 452.

As shown in FIG. 4c, additional services include localisation instances 405, segmentation instances 407, reconstruction instances 409, camera instances 411, and render instances 413. Localization instances 405 includes a set of localisation service instances 415 run in respective containers hosted on servers 417 that collectively comprise a localisation service cluster 419. Segmentation instances 407 includes a set of segmentation service instances 421 run in respective containers hosted on servers 423 that collectively comprise a reconstruction service cluster 425. Reconstruction instances 409 includes a set of reconstruction service instances 427 run in respective containers hosted on servers 429 that collectively comprise a reconstruction service cluster 431. Camera engine instances 411 includes a set of camera engine service instances 433 run in respective containers hosted on servers 435 that collectively comprise a camera engine service cluster 437. Render instances 413 includes a set of render service instances 439 run in respective containers hosted on servers 441 that collectively comprise a render service cluster 443.

Under one embodiment, the (micro-)service instances are implemented using Docker images run in Kubernetes containers. Under Kubernetes nomenclature, Kubernetes pod is a group of containers that are deployed together on the same host, (e.g., the same physical server). A pod is the basic execution unit of a Kubernetes application, and represents processes running on the clusters. A pod encapsulates an application's container (or multiple containers), storage resources, a unique network IP, and options that govern how the container(s) should run. A pod represents a unit of deployment: a single instance of an application in Kubernetes, which might consist of either a single container or a small number of containers that are tightly coupled and that share resources.

Returning to FIG. 4a, Flink instances 404 are shown as being deployed as a pod that comprises a pair of containers and hosted on each Flink server 454, wherein a Flink service instance 456 is run in a first container and a load balancer 458 is run in a second container. Under the Kubernetics embodiment, the Flink service instances 456 are tightly coupled to a respective load balancer 458. As before, Flink servers 454 collectively comprise a Flink service cluster 460.

Distributed architecture 400 further includes a control plane layer 462 and a storage service layer 464. In the illustrated embodiment, control plane service layer 462 is used to implement Kubernetes as a Service and includes an AWS (Amazon Web Services) EKS managed Kubernetes control plane 466. Storage service layer 464 is implemented as a Storage as a Service, and includes AWS S3 configuration and metadata 468 and an AWS xFS managed Lustre filesystem 470. Other cloud hosted service providers and server equipment may also be used, such as provided by Microsoft Azure.

In one embodiment the decoder service instances 418 are implemented as stateful services. Each decoder service instance 418 receives an encoded video feed 472 output from receiver 204 generated by a respective PCam at a constant frame rate. In one embodiment, the frame rate is 30 frames per second (fps). In other embodiments the frame rates are (respectively) 25, 50, and 60 fps. In some embodiments, the video feeds from the J 5K PCams is encoded at a fixed frame rate consuming a variable bandwidth with a target average bandwidth. In other embodiments, the bandwidth of the encoded video signal is fixed or substantially fixed, with a variable frame rate depending on the level of motion of the content. Other services are stateless services, including localization services, segmentation services, reconstructions services and DTX services. Stateless service work tasks are dynamically and asynchronously assigned to available service instances by an orchestration function performed by the Flink service instances 456 in combination with the load balancers 458. Coordination and orchestration of process flows is facilitated by communication between Flink service instances 456 and load balancers 458 and between load balancers 458 and localization service instances 415, segmentation service instances 421, reconstruction service instances 427 DXT service instances 430, camera engine service instances 433 and render service instances 429.

In the illustrated embodiment, the communication is facilitated via gRPC calls 474, 476, and 478. gRPC is an open source high performance RPC (remote procedure call) framework initially developed at Google. It uses HTTP/2 for transport, Protocol Buffers as the interface description language, and is commonly used for connecting services in microservices style architecture. It can efficiently connect services in and across data centers with pluggable support for load balancing, tracing, health checking and authentication.

In the illustrated embodiment, communication between Flink service instances 456 and CVT service instances 448 is implemented using AWS Kinesis Data Streams (KDS) 480, a massively scalable and durable real-time data streaming service supported by AWS. As shown in FIG. 4b, communication between stream aggregation service instances 436 and HLS packager service instances 442 uses the Real-Time Protocol (RTP) 482.

Generally, the servers for a cloud-hosted distributed architecture may employ heterogeneous configurations, where servers in some compute domains (IP clusters) are configured with greater processor capabilities than servers in other compute domains. For example, several of the image processing tasks are graphics intensive and are preferably implemented using one or more graphic processing units (GPUs), while other compute domains may benefit from servers with greater CPU (central processing unit) and/or memory capabilities. In some environments, accelerators or the like may be used in addition to CPUs and GPUs.

In addition, the servers may comprise virtualized compute and memory resources in some implementations. For examples, AWS provides various server configurations including configurations that are implemented on virtualized compute and memory resources. Moreover, in today's disaggregated data center architectures compute and memory resources may be in separate chassis/sleds/trays that are connected over high-speed low-latency fabrics. Accordingly, a “server” as used herein, including the claims, may comprise a physical server or a virtualized server.

As will be recognized by those skilled in the data center arts, containers, such as Docker containers are virtualized execution environments that may be implemented over a host operating system running on physical or virtualized hardware using a virtualization layer that enables platform software and hardware resources to be shared while providing isolation between containers. In addition to the container-based architecture illustrated in FIGS. 4a, 4b, and 4c, other types of virtualization, such as virtual machine (VM) deployments using Type 1 and Type 2 hypervisors or variants such as Linux Xen. Various VM- and container-based environments may also be implemented, including but not limited to Linux KVM, QEMU, XenServer, VMware ESXi, Solaris containers, OpenVZ, and Linux-VServer.

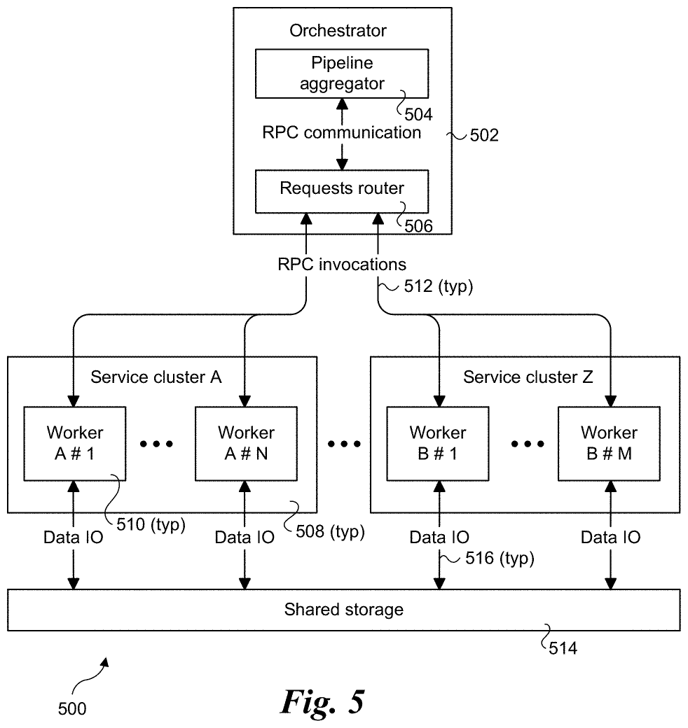

FIG. 5 shows a process flow and communication architecture 500 illustrating selected service flow control components, services, and communication paths. At the top layer of architecture 500 is an orchestrator 502, which includes a pipeline aggregator 504 and a requests router 506. Orchestrator 502 is implemented on a plurality of servers that control, in an asynchronous design, flow of the distributed application (e.g., workflows, direct acyclic graph, and pipelines). In one embodiment, Flink instances are used to implement the functionality associated with pipeline aggregator 504.

Requests router 506 is an application level load balancer that enables communication with computation clusters. Work request to the same service cluster are routed using a routing policy (e.g., round robin, weighted probability table, uniform random, etc.). In one embodiment, the load balancers are Envoy load balancers implemented using the Envoy service mesh.

The middle layer of architecture 500 includes a plurality of service clusters 508. As discussed above, the clusters are grouped by computation domain, with each cluster including a plurality of servers. Generally, the servers within a given service cluster 508 will be homogeneous servers, while the servers in the different service clusters may differ, with more powerful servers used for more computation-intensive tasks.

The servers in each service cluster 508 host workers 510 that are used to process work requests submitted to the service clusters by requests router 506 using RPC invocations 512. In one embodiment, workers 510 are implemented via execution of threads on service instances running in containers on the servers.

The bottom layer of architecture 500 is a shared storage layer 514. As illustrated, workers 510 access storage resources in storage layer 514 using data input/output (TO) links 516. In one embodiment, shared storage layer 514 is implemented as Storage as a Service layer 464 of distributed architecture 400. Under modern data center architectures, such as used for AWS xFS Lustre filesystem 470, servers are coupled to storage resources via a high-speed IO fabric that is represented as data IO links 516.

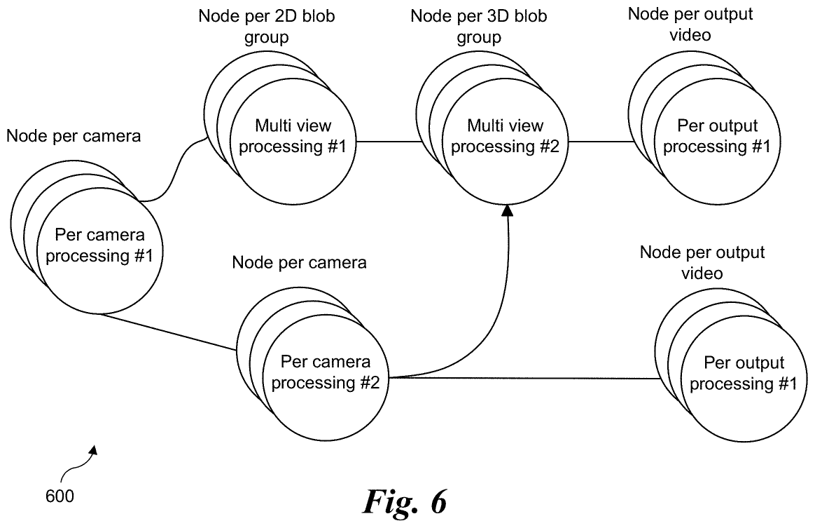

FIG. 6 shows a sample computer vision execution flow used in a multi-view application for volumetric reconstruction. As shown, the execution flow comprises a complex graph with interdependent steps. In order to maintain frame rate throughput (e.g., at 30 fps), mechanisms are needed to ensure real-time output with bounded latency.

In one embodiment, rate control components are implemented at three levels to meet the real-time throughput requirements: Rate control per cluster, rate control per service, and rate control per service worker (per request). Rate control per cluster is the ability to control concurrency and duration of outbound requests to service cluster and their execution duration. Rate control per service is the ability to control concurrency and frequency of inbound requests to service cluster and their execution duration.

Rate control by service workers is achieved through multiple measures. Each service worker is implemented as an asynchronous service (e.g., a microservice under one embodiment). In one embodiment, a service worker will check if a request timeout has passed before taking the following action:
a. Fetching request from Requests Queue into processing thread pool;
b. Before processing loaded data from shared storage;
c. Before storage of processed data; and
d. In case of reaching timeout, service worker will gracefully terminate processing, free the processing thread and fail the request with an error, such as PROCESSING_TIMEOUT.

In one embodiment, a service worker will manage its request queue to be configured with one or more limits. For instance, a number of pending requests received by a service worker may be defined as a percentage of maximum requests the service worker could handle in parallel. (Example: If service worker works with 5 concurrent requests and maximum pending requests equal 120%, then the size of requests queue will be 6.) In case of hitting a limit of maximum pending requests, the service worker will respond to the RPC request with an error, such as RESOURCE_EXHAUSTED, without processing the request any further.

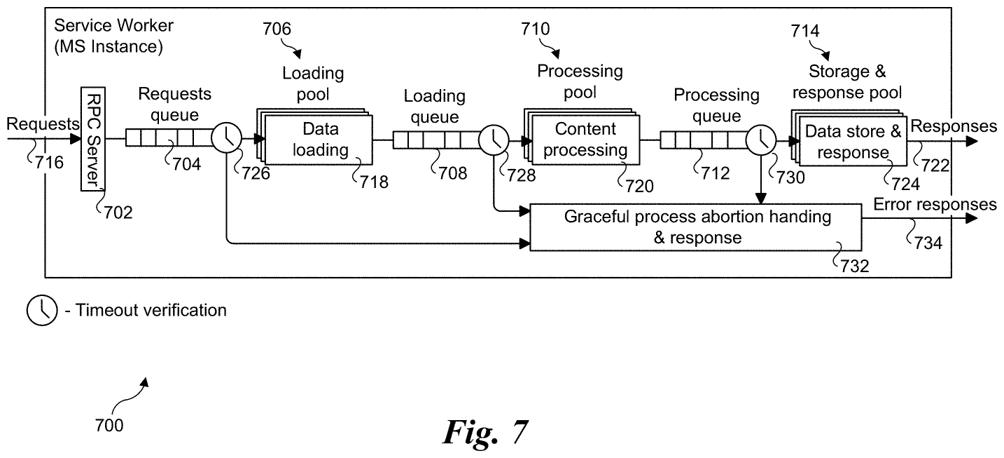

FIG. 7 shows a process pipeline 700 for a service worker, according to one embodiment. Pipeline 700 includes an RPC server 702, a requests queue 704, a loading pool 706, a loading queue 708, a processing pool 710, a processing queue 712, and a storage and response pool 714. In one embodiment, RPC server 702 is a gRPC asynchronous server that accepts work request messages (requests 716) comprising protobufs aligned with an orchestrator and accepts requests with a deadline (execution timeline relative to an orchestrator and/or universal time clock). Protobufs (short for Protocol Buffers) are an open-source language-neutral, platform-neutral, extensible mechanism for serializing structured data. Request queue 704 is a jitter queue that stores incoming asynchronous work requests. In one embodiment, request queue 704 is implemented as a FIFO (First-in, First-out) queue.

Loading pool 706 is a thread pool that verifies the deadline in the protobuf prior to pulling work requests messages from requests queue 704 and fetches input data 718 from shared storage and loads the input data into loading queue 708. Processing pool 710 is a thread pool that verifies the deadline prior to pulling input data from loading queue 708 and performs processing of the input data, as depicted by content processing 720. The output (processing results) of content processing 720 is stored in processing queue 712.

Storage and response pool 714 is a thread pool that verifies the deadline (execution timeline) prior to pulling processing results from processing queue 712 and stores the processing output into shared storage and issues a response 722 back via gRPC Asynchronous server, as depicted by data store and response operations 724.

As shown by the flows emanating from timeout verification icons 726, 728, and 730 and flowing into a block 732 and error responses 734, in the event a deadline is exceeded the service worker gracefully cleans up resources and reports back with DEADLINE_EXCEEDED error code. In addition, each of request queue 704, loading queue 708 and processing queue 712 has capacity limit that if reached will cause the process (for a given request) to be aborted and returning a request response comprising a RESOURCE_EXHAUSTED error code.

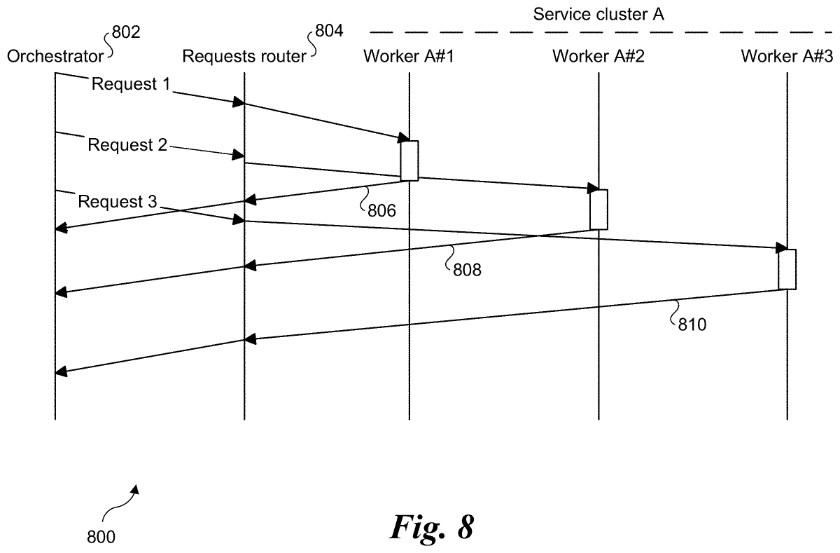

One or more work request distribution schemes and related routing policies may be implemented by the orchestrators herein. For example, FIG. 8 shows a diagram 800 illustrating an embodiment of a round robin routing policy. An orchestrator 802 sends work requests 1, 2, and 3 to a request router 802, which routes the respective work requests to Workers A #1, A #2, and A #3 in a service cluster A. Upon completion of performing work associated with its respective work request, each of Workers #1, A #2, and A #3 return a respective completion notification 806, 808, and 810 to request router 804, which, in turn, forwards the completion notifications to orchestrator 802. In one embodiment, orchestrator 802 is implemented as an instance of a Flink service 456 and request router is implemented as an instance of a load balancer 458 of FIG. 4a. Other routing policies may also be implemented in a similar manner.

Another work request distribution scheme considers the level of backlog for the service workers, which is tracked by in real-time. Under this approach, when there are multiple service workers that are configured to perform a given task, the task is routed to the service worker (among these) with the least backlog.

In one aspect, an orchestrator and/or its associate load balancer instances tracks the work status of the service instances in the various service clusters managed by those instances. For example, work status may include “available” or “idle” and “unavailable” or “working.” The dispatch of work requests is generally asynchronous, and different work tasks within a given service cluster may take different lengths of time (referred to as execution durations) depending on the complexity of a particular frame or frame sequence. For example, work tasks associated with performing localisation, segmentation, and reconstruction may have different execution durations depending on the amount of entities observed in the video streams. In addition, valid output can be produced even with partially complete intermediate results: partial localization, segmentation or reconstruction might affect quality any specific frame but will not harm the validity of the final output of the system.

Rate control by Orchestrator (Per Service Cluster)

Rate control is also performed by the orchestrator on a per-cluster basis. In one embodiment, the orchestrator will enable limits to be defined to limit the number of open requests dispatched to specific clusters based on system configuration (e.g., maximum number of requests per service Cluster). When a defined limit of open request for a cluster is reached, the orchestrator will drop requests for that cluster until such time the number of open request is below the limit again.

In another embodiment, the orchestrator will enable limits to be defined to limit the number of open requests dispatched to specific clusters based on system configuration (e.g., maximum number of requests per service cluster). When a defined limit of open request for a cluster is reached, the orchestrator will queue the requests for that cluster internally until such time the number of open request is below the limit again, at which point it will dispatch the queued requests.

In one embodiment, the orchestrator will initiate each request with a predefined execution duration (e.g., deadline) per service cluster. In case of expiration of deadline, the orchestrator will apply one of following retry policies in correlation with the routing policy defined by the requests router:
a) Orchestrator may fail the request, with no retries; or
b) Orchestrator may resubmit a request deducing execution duration by constant of measured duration or previous request.
   It is noted the foregoing list of retry policies is merely exemplary and not to be limiting, as other retry policies may also be implemented.

In the event of receiving a RESOURCE_EXHAUSTED error (returned from a service worker), the orchestrator will retry the request via the requests router with predefined routing policy.
a) For each sequential retry, the orchestrator will determine the execution duration that was spent on the previous try (or retry).
b) The number of retries may be capped by configuring per cluster a maximum cumulative execution duration.
c) After reaching maximum execution duration, the request will be aborted with no retries.

While using plurality of servers in order to conduct streaming processing of video data there is a functional need to preserve temporal state of most of the nodes participating in process. In particular, there is a need to enable periodic external configuration updates during runtime in a synchronized manner for such a distributed system.

Additionally, use of a large number of servers introduces non-zero probability of hardware failures. To address this, the system provides only health-checks to detect and/or predict hardware failures. The system is also configured to retrieve application state that is fully synchronized with the rest of the system without quality degradation and sacrificing real-time aspect of the application.

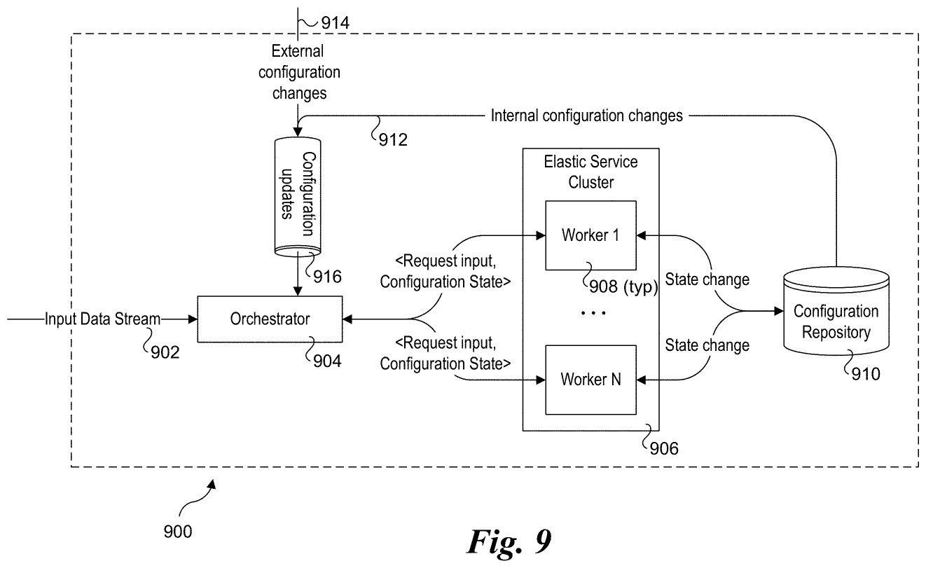

FIG. 9 shows a processing sub-system 900 that uses stateless workers within stateful clusters and includes components and messaging for preserving temporal state and coordination process flows to effect configuration updates. The key components include an input data stream 902, an orchestrator 904, an elastic service cluster 906 including multiple service worker units 908, a configuration repository 910, and internal and external configuration that may be updated by internal configuration changes 912 and external configuration changes 914, which are collectively produce configuration updates 816 to update the configuration state.

Input data stream 902 is a high frequency data stream that includes input data references or content. Orchestrator 904 comprises a processing engine that maintains information associated with the state of each service working unit 908, application state, and configuration states of each service cluster 906. Orchestrator 904 is responsible for invocation of service Clusters 906 based on an application execution graph.

Elastic service Cluster 906 is a logical envelope of plurality of homogeneous servers that are used to host a plurality of worker instances (aka worker units) that perform the same task. A working unit 908 is an instance of a single execution unit that is invoked by orchestrator 904 directly or via routing media. Configuration repository 910 is a component that is responsible for state aggregation and propagation for all service Clusters.

The internal/external configuration is a single configuration asset or key, value pair associated with one or several service Clusters. The configuration state is a list of configurations associated with specific service Clusters.

The approach implemented by processing sub-system 900 produces separation of responsibilities by which orchestrator 904 is responsible for joining input data stream requests that are propagated via the system with high frequency with relevant configuration state currently. The implementation also supports a low frequency modification pattern while preserving the temporal state of the system components.

To support streaming of time-based data series (video or image sequences), each data stream work unit is keyed with time code (e.g., a frame id or timestamp). Each internal and external configuration also has a time code indicating the period during which the configuration is being active in the system. This aspect supports synchronizing of worker units within a selected cluster.

LISTING 1 shows an example of a configuration state (in JSON format).

LISTING 1

{

modified_at: 150,
configurations: [{

configuration_name: “calibration_data”,
current_value: “Reference URI”,
new_value: “Reference URI”,
update_at: 140

},
{

configuration_name: “camera_position”,
current_value: “Value”,
new_value: “Value”,
update_at: 150

}

]

}

Each configuration has four fields:
Configuration name—main key for configuration differentiation;
Current value—value/reference of configuration that had been published before an update;
New value—value/reference that had been published with update; and
Update at—Time code from which New value configuration is being active

This double buffering approach serves two primary purposes. First, it denotes the current value of the configuration for a Worker that had been added into the system without prior executions. Second, it provides the ability to pre-fetch (cache) configuration updates before the configuration change had been applied on the service Cluster.

Worker Execution Steps

In one embodiment, the worker execution steps include the following:
1) During each invocation, the worker extracts time code out of invocation input data.
2) By comparing the time code with every configuration in the configuration state analysis configurations that are relevant for current execution are determined.
3) Fetching or pre-fetching relevant configuration assets
4) Execute main service process
5) Propagate configuration changes if applicable into the Configuration repository
6) Finish request execution

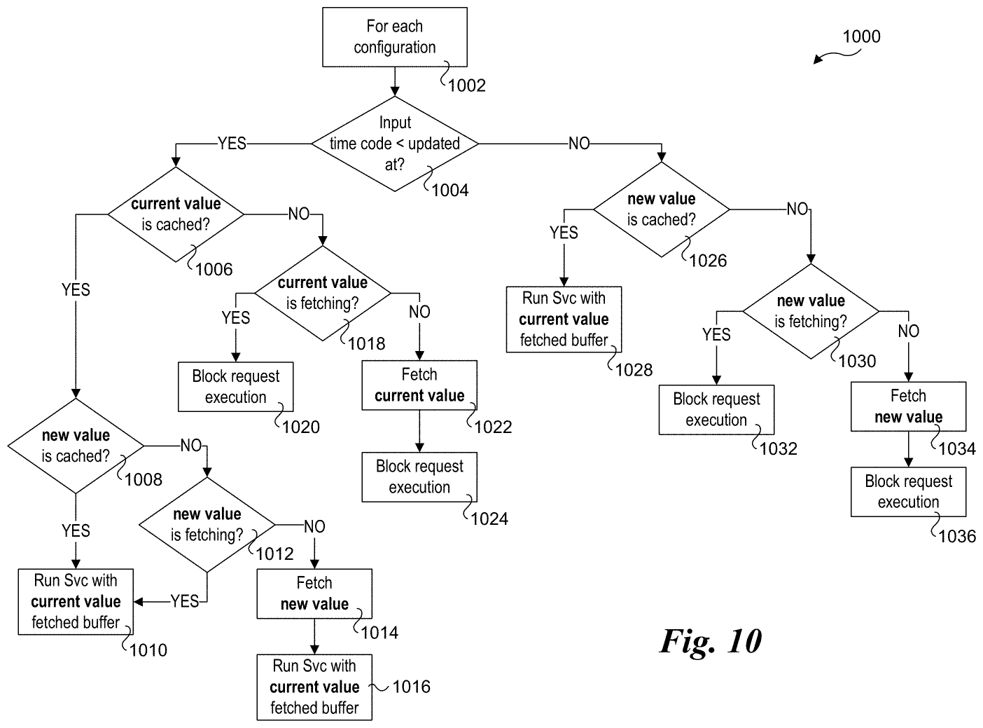

Caching and synchronization policy decision tree 1000 of FIG. 10 describes in more detail how configurations are handled during every execution providing fully synchronized service cluster in a sense of loaded configurations in every worker. The decision tree logic proceeds as follows. At the top of decision tree 1000 is a block 1002 indicating the decision tree logic applies to every configuration. In a decision block 1004 a determination is made to whether the input time code is less than update at time code. If the answer is YES (TRUE), the logic proceeds to a decision block 1006 in which a determination is made to whether the current value is cached. If YES, to logic proceeds to a decision block 1008 to determine whether the new value is cached. If YES, the logic proceeds to run the service with the current value in the fetched buffer, as depicted in a block 1010.

If the answer to decision block 1008 is NO (FALSE), the logic proceeds to a decision block 1012 to determine whether the new value is fetching. If YES, the logic proceeds to block 1010. If NO, the logic proceeds to a block 1014 in which a new value is fetched and a block 1016 in which the service is run with the current value fetched from the buffer.

Returning to decision block 1006, if the current value is not cached the logic proceeds to a decision block 1018 to determine whether the current value is fetching. If YES, the logic proceeds to block request execution, as depicted in a block 1020. If the answer to decision block 1018 is NO, the current value is fetched in a block 1022 and request execution is blocked in a block 1024.

Returning to decision block 1004, if the input time is not less than the time the code is updated, the answer is NO and the logic proceeds to a decision block 1026 to determine whether the new value is cached. If it has (YES), the service is run with the current value fetched from the buffer, as depicted in a block 1028. If the answer to decision block 1026 is NO, the logic proceeds to a decision block 1030 to determine whether the new value is fetching. If YES, execution of the request is blocked in a block 1032. If NO, the new value is fetched in a block 1034 and execution of the request is blocked in a block 1036.

The foregoing approach also provides support for out of order execution (time code with jitter) for moderate frequency of configuration updates. In case of higher frequency requirements, configuration state can be extended by trail of more than two historical configuration values.

Processing sub-system 900 of FIG. 9 and caching and synchronization policy decision tree 1000 support multiple use cases, including periodic updates of calibration data throughout the majority of service clusters in an application. They also may be used to provide clean background image propagation for high quality segmentation with a rate of 1 per 5 seconds for each PCam, in one embodiment. They further may be used to provide stabilization values—data that is modified within a service cluster of multi-view stabilization with an initial state provided as an external configuration state.

Generally, the functionality provided by orchestrator 904 may be implemented in one or more of the orchestrator components described herein, such as Flink service instances 456 in FIGS. 4a and 4c and orchestrator 502 in FIG. 5. Similarly, various operations and functionalities associated with workers, service clusters, and/or service instances in a given Figure may be implemented in workers, service clusters, and/or service instances in other Figures.

The embodiments disclosed herein provide a solution for implementing real-time multi-view processing of many video streams in parallel. The solution leverages advantages provide by cluster-based deployments supporting elasticity, containerization, network meshes. The solution may be implemented utilizing cloud services with a wide variety of computer vision applications. For example, the solution may be applicable for Direct Acyclic Graphs, modular and flexible pipeline executions or workflows. The solution also supports fusion of both stateless and stateful application clusters.

In the foregoing examples, the real-time multi-view processing approaches were described in the context of sporting events at stadiums and other venues. However, this is not meant to be limiting, as similar approaches may be used for any type of live event at various types of venues in which multiple PCAMs are installed, such as but not limited to concerts, theatrical productions, political events, etc.

In the foregoing embodiments, the real-time multi-view processing approaches are implemented in a data center that is remote from the stadium or venue. However, similar approaches may be implemented on-premise (e.g., at the stadium or venue) with the appropriate equipment and services. For example, Amazon® AWS on premise (called AWS Outposts, or alternatively Hybrid Cloud with AWS) enables companies to implement AWS cloud services on-premise. Accordingly, in one embodiment, AWS Outposts is used at the stadium or venue site.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Italicized letters, such as ‘J’, ‘K’, ‘L’, ‘M’, ‘N’, ‘O’, etc. in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or a virtual machine or container hosted by software running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method for producing immersive sports video content comprising:
receiving, at a data center, a plurality of video feeds from a plurality of physical cameras (PCams) installed in a stadium or venue, each PCam having a respective viewpoint directed toward at least one of a field or court in the stadium or venue and one or more players participating in a sport being played in the stadium or venue;
processing the plurality of video feeds in parallel at the data center using a plurality of distributed stateful and stateless processing services to,
generate a three-dimensional point cloud comprising a volumetric model including a plurality of voxels; and
process the plurality of voxels from each of a plurality of viewpoints associated with respective virtual cameras (VCams) to output at least one video stream.

2. The method of claim 1, wherein each of the plurality of video feeds from the plurality of PCams comprises an encoded video stream having an original frame rate and wherein one or more of the at least one video stream that is output has a frame rate matching the original frame rate.

3. The method of claim 2, wherein the original frame rate is 25, 30, 50 or 60 frames per second.

4. The method of claim 1, further comprising:
employing at least one instance of an orchestrator to distribute stateless processing tasks to a plurality of workers, each worker comprising a unit of execution configured to perform a particular processing task.

5. The method of claim 4, further comprising:
receiving a work request for an orchestrator;
beginning processing the work request using a workflow including a plurality of stages;
determining, for at least one of the plurality of stages, whether a request timeout for the work request has passed; and
if the request timeout has passed, terminating processing of the work request.

6. The method of claim 4, wherein the plurality of workers are executed on a plurality of servers grouped by computational domain into a plurality of service clusters, further comprising:
controlling concurrency and duration of outbound work requests issued from the orchestrator to the service clusters and execution duration of the work requests.

7. The method of claim 4, wherein at least a portion of the plurality of stateless processing tasks are implemented as microservices.

8. The method of claim 4, wherein generating the plurality of voxels in implemented using a pipeline including a localization block followed by a segmentation block followed by a reconstruction block, and wherein a number of instances of the localization block, the segmentation block and the reconstruction block can be configured independently from one another.

9. The method of claim 4, further comprising:
while operating under a first configuration, processing the plurality of video feeds in parallel using the workers to output the at least one video stream at an initial frame rate;
dynamically changing the first configuration to a second configuration while continuing to process the plurality of video feeds in parallel using the workers while maintaining the initial frame rate.

10. The method of claim 9, wherein the plurality of workers are executed on a plurality of servers grouped by computational domain into a plurality of service clusters, further comprising:
receiving or accessing, at an orchestrator, at least one of an internal configuration change and an external configuration change comprising at least one configuration update;
generating a configuration state update based on the at least one configuration update; and
sending, via the orchestrator, a configuration state update to a plurality of workers in at least one service cluster.

11. A system implemented in a data center, comprising a plurality of clusters of servers on which software is executed to perform a plurality of stateful and stateless processing tasks in parallel to enable the system to:
process a plurality of video feeds received from a plurality of physical cameras (PCams) installed in a stadium or venue, each PCam having a respective viewpoint directed toward at least one of a field or court in the stadium or venue and one or more players participating in a sport being played in the stadium or venue;
generate a three-dimensional point cloud comprising a volumetric model including a plurality of voxels; and
process the plurality of voxels from each of a plurality of viewpoints associated with respective virtual cameras (VCams) to output at least one video stream.

12. The system of claim 11, wherein each of the plurality of video feeds from the plurality of PCams comprises an encoded video stream having an original frame rate and wherein one or more of the at least one video stream that is output has a frame rate matching the original frame rate.

13. The system of claim 11, wherein the original frame rate is 25, 30, 50, or 60 frames per second.

14. The system of claim 11, wherein the plurality of clusters of servers include:
a plurality of service clusters grouped by computational domain, each service cluster including at least one server hosting at least one worker to perform a stateless processing task and associated with the computational domain of the service cluster; and
an orchestration cluster, running at least one instance of an orchestrator configured to distribute work requests to workers in the plurality of service clusters.

15. The system of claim 14, wherein at least a portion of the workers are configured to:
receive a work request for an orchestrator;
begin processing the work request using a workflow including a plurality of stages;
determine, for at least one of the plurality of stages, whether a request timeout for the work request has passed; and
if the request timeout has passed, terminate processing of the work request.

16. The system of claim 14, wherein the system is further configured to control concurrency and duration of outbound work requests issued from an orchestrator to the service clusters and execution duration of the work requests.

17. The system of claim 14, wherein at least a portion of the plurality of stateless processing tasks are implemented by workers as microservices.

18. The system of claim 14, wherein the plurality of clusters of servers include a cluster of servers hosting instances of decoder service implemented as stateful processes, wherein each decoder service instance is configured to decode a respective video feed received from a respective PCam and generate decoded video frames.

19. The system of claim 14, wherein the system is further configured to:
while operating under a first configuration, process the plurality of video feeds in parallel to output the at least one video stream at an initial frame rate; and
dynamically change the first configuration to a second configuration while continuing to process the plurality of video feeds in parallel while continuing to output the at least one video stream at the initial frame rate.

20. The system of claim 11, wherein the system is further configured to:
receive or access, at an orchestrator, at least one of an internal configuration change and external configuration change comprising at least one configuration update;
generate a configuration state update based on the at least one configuration update; and
send, via the orchestrator, a configuration state update to a plurality of workers in at least one service cluster.

21. At least one non-transitory computable-readable medium in which a plurality of distributed software components are stored, wherein the distributed software components are configured to be executed on a plurality of servers in a cloud-hosted system to perform a plurality of stateless and stateful processing tasks using a distributed architecture, wherein execution of the plurality of distributed software components on the plurality of servers enables the cloud-hosted system to:
process, in parallel, a plurality of video feeds received from a plurality of physical cameras (PCams) installed in a stadium or venue that is remote from the cloud-hosted system, each PCam having a respective viewpoint directed toward at least one of a field or court in the stadium or venue and one or more players participating in a sport being played in the stadium or venue;
generate a three-dimensional point cloud comprising a volumetric model including a plurality of voxels; and
process the plurality of voxels from each of a plurality of viewpoints associated with respective virtual cameras (VCams) to output at least one video stream,
wherein each of the plurality of video feeds from the plurality of PCams comprises an encoded video stream having an original frame rate and wherein one or more of the at least one video stream that is output has a frame rate matching the original frame rate.

22. The at least one non-transitory computer-readable medium of claim 21, wherein the plurality of software components include an orchestrator and software components for implementing a plurality of microservices, each microservice to implement a stateless processing task associated with a computational domain, wherein a portion of the plurality of servers in the cloud-hosted system are configured as a plurality of service clusters grouped by computational domain, each service cluster including at least one server hosting at least one instance of a microservice associated with the computational domain of the service cluster, wherein the plurality of servers further include an orchestration cluster running at least one instance of the orchestrator, wherein each instance of the orchestrator is configured to distribute work requests to instances of microservices.

23. The at least one non-transitory computer-readable medium of claim 22, wherein the plurality of software components further include a load balancer that is either part of an orchestrator or configured to be executed as an instance of a load balancer on each of at least one server in the orchestration cluster, wherein a load balancer is used to route work requests to instances of microservices.

24. The at least one non-transitory computer-readable medium of claim 22, wherein the cloud-hosted system includes a storage layer implemented as a Storage as a Service (SaaS), and wherein at least a portion of the instances of microservices are configured to access data written to the storage layer by at least one of an orchestrator and another microservice.

25. The at least one non-transitory computer-readable medium of claim 22, wherein the instances of microservices are implemented in containers hosted by the plurality of servers, and the service clusters are implemented as Kubernetes pods.
